(19) United States
(12) Patent Application Publication
(10) Pub. No.: US 2017/0100612 A1
(43) Pub. Date: Apr. 13, 2017

(54) HOOD FOR CLEANROOM GOWN AND CLEAN ROOM GOWN

(71) Applicant: Initial Textil Service GmbH & Co. KG, Lingen (DE)

(72) Inventors: Jean-Philippe Conge, Draveil (FR); Maëva Banchereau, Duttlenheim (FR); Johanna Menza, Strasbourg (FR); Christine Jean-Struss, Strasbourg (FR)

(21) Appl. No.: 15/287,818

(22) Filed: Oct. 7, 2016

(30) Foreign Application Priority Data
Oct. 8, 2015 (EP) 15306592.5

(51) Int. Cl. A62B 17/04; A41D 13/11; A62B 7/10; A41D 13/02; A62B 18/02; A62B 18/10

(52) U.S. Cl. CPC A62B 17/04; A62B 18/02; A62B 18/10; A62B 7/10; A41D 13/02; A41D 13/1153; A41D 13/1184

(57) ABSTRACT

The invention concerns a hood for a cleanroom gown, the hood comprising a base body defining an outside and an inside adapted to receive a head of an operator, the base body having a visor opening having a lower border and an upper border, wherein the hood includes a visor fixed in the visor opening, wherein the visor comprises a visor circumference with an upper border and a lower border, the lower border comprising a nose cut-out or a nose bulge provided for a nose of the operator, characterized in that the hood further comprises at least one fixing device arranged at an upper end of the nose cut-out or at the front end of the nose bulge for releasably fixing the lower border of the visor opening to the visor.

### CROSS REFERENCE TO RELATED APPLICATIONS

This application claims priority under 35 USC §119 of European Patent Application No. 15 306 592.5 filed on Oct. 8, 2015.

### FIELD OF THE INVENTION

The present invention concerns a hood for a cleanroom gown, the hood comprising a base body defining an outside and an inside adapted to receive a head of an operator, the base body having a visor opening having a lower border and an upper border, wherein the hood includes a visor fixed in the visor opening, wherein the visor comprises a visor circumference with an upper border and a lower border, the lower border of the visor comprising a nose cut-out or a nose bulge provided for a nose of the operator, as well as a corresponding cleanroom gown comprising such a hood.

### BACKGROUND OF THE INVENTION

Cleanroom gowns are used in cleanrooms for protecting the object to be manipulated by an operator from dust and other microscopic particles carried by the operator. Example of cleanrooms are: packaging facilities for medicine items and manufacturing plants for microelectronic products, such as microchips.

The known cleanroom gowns comprise a hood having a visor opening. The visor is usually strapped around the head and is in the form of a goggle. The goggles are difficult to manipulate and tend to not seal the head completely off the outside.

According to other known cleanroom gowns, for example as known from EP 2 781 167 A1, these comprise a visor opening, wherein the hood has fixing means adapted to releasably fix the visor to the hood.

However, these kinds of gowns and hoods have a reduced field of view and tend to fog up during usage. Further, operators have problems when looking downwards. Such kinds of cleanroom gowns have a poor filtration of particles in front of the mouth. Additionally, a high CO₂ concentration was detected within the hoods.

Further, standards and guidelines are becoming more stringent for producers in sensible fields, in particular in the pharmaceutical industry. The pharmaceutical industry is continuously searching for ways to exclude human contamination in their production process and on/in their products.

### SUMMARY OF THE DESCRIPTION

Object of the invention is to provide an improved hood, which has a high operational security and is comfortable to wear for an operator. It should ascertain a clear vision. Further, the hood should be easy to clean and economic.

According to an aspect, a hood is provided for a cleanroom gown, the hood comprising a base body defining an outside and an inside adapted to receive a head of an operator, the base body having a visor opening having a lower border and an upper border, wherein the hood includes a visor fixed in the visor opening, wherein the visor comprises a visor circumference with an upper border and a lower border, the lower border of the visor comprising a nose cut-out or a nose bulge provided for a nose of the operator, wherein the hood further comprises at least one fixing device arranged at an upper end of the nose cut-out or at the front end of the nose bulge for releasably fixing the lower border of the visor opening to the visor.

Further embodiments may include the following features, which may be combined in any technical feasible combination:
the hood defining a central axis, the nose cut-out or the nose bulge of the visor being symmetrically to the central axis, wherein at least one of the fixing devices is arranged on the central axis;
the fixing device includes a first portion arranged on the visor and a second and/or third portion arranged at the lower border of the visor opening;
the fixing device is a pressure button, a press snap button, a metal hook/lace fastener and/or a hook and loop fastener;
the visor is releasably fixed to the base body by a fixing groove extending around the visor opening and adapted to receive the visor circumference;
the nose cut-out has a length between the upper end and an lower end between 3 and 6 cm, in particular between 4 and 5 cm;
the hood further comprises at least one spacing element adapted to hold the upper border of the visor in a predetermined distance from the forehead of the operator, wherein, in particular the predetermined distance is between 3 and 10 cm;
the at least one spacing element is adapted to be supported by at least one portion of the head of the operator and/or is rigid, in particular is a rigid ring, fixed to the base body;
the hood further comprises at least one sealing device arranged at the lower border of the visor opening adapted to seal a space between the lower border of the visor opening and a portion of the face, in particular the cheeks, of the operator, wherein the, in particular each sealing device extends between the nose cut-out of the visor and one of the lateral borders of the visor opening;
the sealing device has a thickness of between 10 mm and 70 cm, in particular between 20 and 50 mm;
the hood further comprises an inhalation and exhalation device adapted to retrieve intake air for inhalation from a first direction, in particular in a front direction, and to exhaust exhaled air in a second direction being different of the front direction, wherein, in particular, the inhalation and exhalation device is a passive device;
the inhalation and exhalation device includes a mask portion comprising at least one one-way valve, in particular one intake air one-way valve and/or one exhaust air one-way valve;
the inhalation and exhalation device includes a filtering device for filtering the exhaled air, wherein, in particular, the filtering device is connected to the mask portion with a tubing and/or includes an filtering fabric for filtering particles; and/or
the hood further comprises a releasable pressing device for pressing the mask portion onto the face of the operator and/or for pressing the lower border of the visor against the cheek of the operator, wherein, in particular, the pressing device is provided on the outside of the hood.

According to a further aspect, a cleanroom gown is provided comprises a body portion, arms, legs and a hood according to an embodiment disclosed herein.

### BRIEF DESCRIPTION OF THE DRAWINGS

So that the manner in which the above recited features of the present invention can be understood in detail, a more particular description of the invention, briefly summarized above, may be read by reference to embodiments. The accompanying drawings relate to embodiments of the invention and are described in the following:

FIG. 1 shows schematically a front view of a hood according to an embodiment of the invention;

FIG. 2 shows schematically a front view of a visor;

FIG. 3 shows schematically a sectional view according to line A-A in FIG. 1;

FIG. 4 shows schematically a side view of a hood according to an embodiment of the invention;

FIG. 5 shows schematically a side view of an inhalation and exhalation device of a hood according to another embodiment of the invention;

FIG. 6 shows a section Y-Y of an exhalation opening according to the embodiment of FIG. 5;

FIG. 7 shows a top view of an exhalation opening or one-way valve according to a further embodiment;

FIG. 8 shows another embodiment of a hood according to an embodiment of the invention; and

FIG. 9 shows a further embodiment of a hood according to an embodiment of the invention.

### DETAILED DESCRIPTION

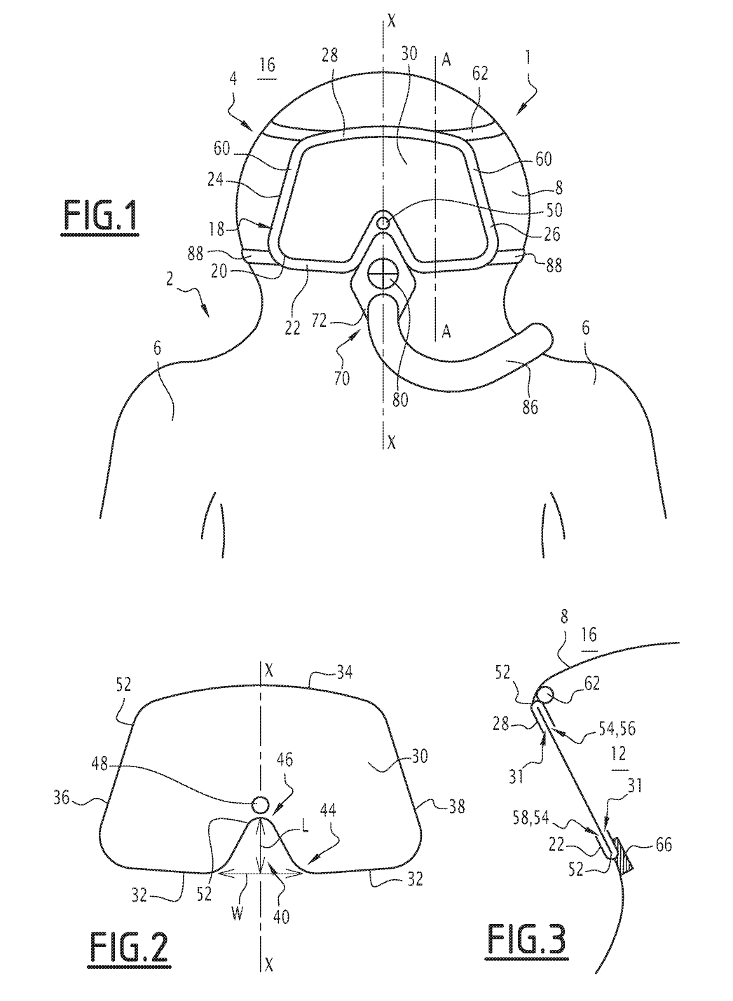

FIG. 1 shows schematically a front view of a cleanroom gown 1 according to an embodiment of the invention. The cleanroom gown 1 comprises a body portion 2 and a hood 4, as well as arms 6 and non-represented legs.

The hood 4 comprises a base body 8. The base body 8 is preferably formed integrally with the body portion 2 of the gown. Alternatively, the cleanroom gown 1 comprises a body portion 2 and a hood 4, whereby the hood 4 is separate, i.e. detached, from the body portion 2. Still alternatively, the body portion 2 is in the form of a coat.

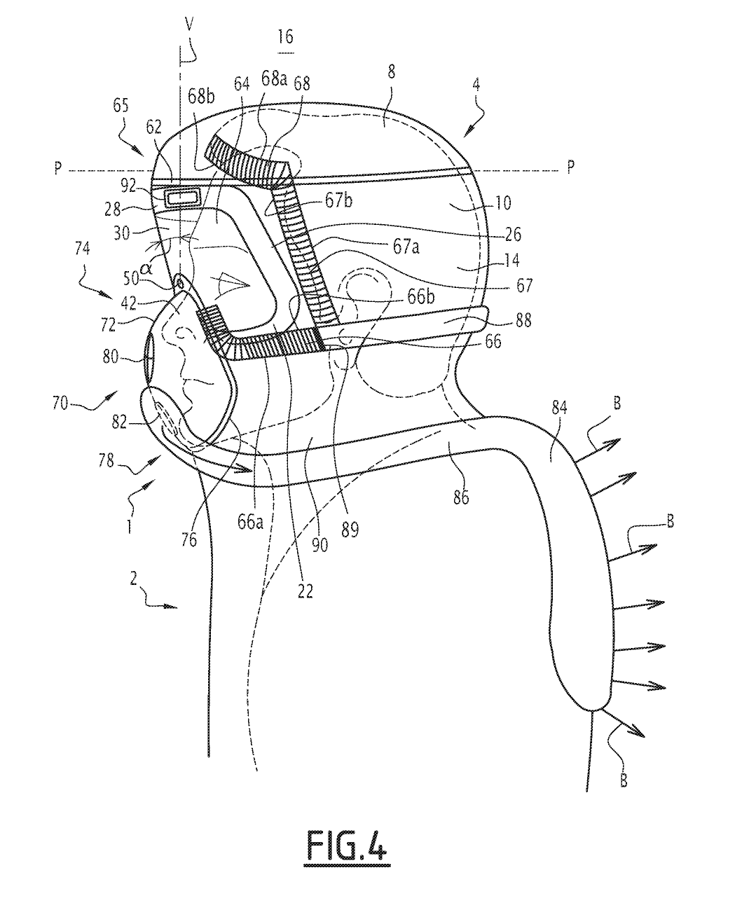

The hood 4 defines a hood central axis X-X, which extends substantially vertical or along the central axis of a head of an operator 10, when the hood is used by the operator 10 (shown in FIG. 4).

It should be noted that in the present invention the terms “above”, “below”, “upper”, “lower”, “central”, “lateral”, “top”, “bottom”, “horizontal”, “vertical”, “front” and “back” are used for defining the hood 4 when being worn by the operator 10 and in the perspective of the operator 10, when the operator has his head in the upright position as shown in FIG. 4. In other words the front part of the hood 4 is in front of the face of the operator 10 and the back part of the hood 4 is behind the head or the back of the operator 10.

The base body 8 confines an inside 12 adapted to receive a head 14 of the operator 10 and delimits the inside with respect to an outside 16 (see FIGS. 3 and 4).

The base body 8 has also a visor opening 18. The visor opening 18 is substantially rectangular and extends in front of a region of the eyes of the operator when the hood 6 is worn. The visor opening 18 defines a visor opening circumference 20 comprising a lower border 22, two lateral borders 24, 26 and an upper border 28. The lateral borders 24, 26 are connecting the lower border 22 to the upper border 28.

At least the lower border 22, in particular all borders 22, 24, 26, 28 are formed from a flexible material, for example cleanroom fabric. In other words they are not stiff and cannot retain a specific shape without a reinforcing device and/or a visor.

The hood 6 comprises furthermore a visor 30 and fixing means 31 adapted for releasably fixing the visor 30 to the base body 8 in the visor opening 18.

As can be seen in FIG. 2, the visor 30 is a transparent plate which is, in a non-constraint configuration, completely flat or plane. In other embodiments, the visor 30 is in the non-constraint configuration rounded. The general shape of the visor 30 is rectangular or trapezoidal with rounded corners. In particular the visor 30 has a lower border 32, an upper border 34 and two lateral borders 36, 38 connecting the lower border 32 to the upper border 34. According to an embodiment, the lateral borders 36, 38 are shorter than the lower border 32 and/or the upper border 34.

Further, the visor presents at its lower border 32 a concave nose cut out 40. The nose cut-out 40 and/or the visor 30 are symmetrically to the central axis X-X. The nose cut out 20 extends over the nose 42 (see FIG. 4) of the operator 10 when the hood 4 is worn. The nose cut-out 40 has a length L in the direction of the central axis X-X. The nose cut-out 40 has a width W at a lower end 44 in transversal direction. The transversal direction is orthogonal to the central axis X-X. The nose cut-out tapers from its lower end 44 to its upper end 46. In an embodiment, the width W is between 3 and 8 cm, for example about 6 cm, and the length L is between 3 and 6 cm, for example about 4.5 cm. The nose cut-out has substantially the shape of a nose. The nose cut-out enables to isolate the visor from the hot, moisturized air coming from the mouth, though reducing condensation dramatically and brings the bottom or lower border 32 of the visor 30 closer to the cheeks to further improve downward vision.

In another embodiment, the visor includes a nose bulge covering the nose, substantially the complete nasal bone, in particular down to the nose tip. The nose bulge extends to the front direction. In an embodiment, the nose bulge is open in downward direction to enable breathing through the nose. According to an embodiment, the nose bulge substantially conforms to the nose of the operator.

According to an embodiment, the visor 30 is provided with at least one first portion 48 of a fixing device 50 (see also FIG. 4). For example, the at least one first portion 48 of the fixing device may be arranged on the central axis X-X at the upper end 46 of the nose cut-out 40.

In an embodiment, the at least one first portion 48 of the fixing device 50 is arranged in a distance between 0.5 and 2 cm from an edge or circumference 52 of the visor 30.

The embodiment shown in FIGS. 1, 2 and 4 shows only one fixing device 50. In other embodiments, a plurality of fixing devices 50 are arranged at the upper end 46 of the nose cut-out 40, for example symmetrically with respect to the central axis X-X.

In the embodiment of a nose bulge the fixing device is provided at the front and/or lower end of the nose bulge. The front end of the nose bulge is positioned close to the nose tip of the operator. In other embodiments, a plurality of fixing devices 50 are arranged at the around the lower end of the nose bulge, for example symmetrically with respect to the central axis X-X.

The fixing device 50 is provided to releasably fix the lower border 22 of the visor opening 18, in particular a portion of the lower border 22, at the nose cut-out or the nose bulge, to the visor, such that lower border 22 of the visor opening 18 follows closely the edge or circumference 52 of the visor 30. Without the fixing device 50, there would be an opening between the lower border 22 of the visor opening and the upper end 46 of the nose cut-out 40 or the front end of the nose bulge.

For example, the fixing device 50 is a pressure button, a press snap button, a zip fastener and/or a hook and loop fastener (Velcro fastener). In another embodiment a (single) metal hook/lace fastener or metal hook/loop fastener. Instead of metal another rigid material may be used. In some embodiments, the first portion 48 of the fixing device 50 is a lower or upper portion of the pressure button, the lower or upper portion of press snap button and/or a hook portion or a loop portion of a hook and loop fastener. In other embodiments, the first portion 48 of the fixing device 50 is an opening through which the other portions of the fixing 50 device are connected.

The visor 30 is integrally made, in particular in one piece, from plastic such as polycarbonate. Alternatively, the visor 30 is made from any other material usable for cleanroom use. The visor 30 is flexible and can be bent elastically into a concave shape. For example, the visor 30 is an anti-fog visor and may contain an anti-fog coating on the inner side.

The fixing means 31 are adapted to fix the visor 30 to the base body 8 substantially along the visor circumference 22 and in particular substantially along the complete visor circumference 22. The fixing means 31 are adapted to fix the visor 30 to the base body 8 along substantially the whole visor opening circumference 20. In other words, the visor 30 is held in place by the clean room fabric of the hood 4.

As it can be seen in FIG. 3, to this end, the fixing means 31 comprise a fixing groove 54 extending around the visor opening 18 and adapted to receive the visor circumference 52, in particular adapted to receive the whole visor circumference 52. In an embodiment, the fixing groove may be formed by a reinforced fabric. Thus, the form of the groove 54 may be stable.

The fixing groove 54 has an upper fixing groove part 56, a lower fixing groove part 58, and two lateral side fixing groove parts (not shown).

In an embodiment, the fixing means 31 define an insertion opening (not shown) and closing means or fastening means adapted to close the insertion opening. In the fastened state of the closing means, the insertion opening is closed and forms part of the fixing groove. For example, the closing means comprise press snap buttons. Alternatively or complementary, the closing means can comprise a zipper and/or a hook-and-loop fastener or any other closing means that can be closed and re-opened in a non-destructive and reversible manner.

For example, the insertion opening and the closing means are arranged on a lateral border 24, 26 of the visor opening 18 and extend substantially parallel to the hood central axis X-X. In other embodiments, the insertion opening may be provided at the upper border 28 of the visor opening and extend in traverse direction to the hood central axis X-X.

The fixing means 31 are adapted to allow an insertion and/or retraction of the visor 30 into/from the position in which the visor 30 is fixed to the base body 8 over the visor opening 18 by sliding. When the closing means are unfastened, the insertion opening is open and the visor 30 is insertable through the insertion opening into the fixing groove 54 by a sliding movement.

In other embodiments, the visor 30 is inserted from the interior of the visor opening 18 and subsequently held in place when closing the fixing device 50.

In an embodiment, both, the interior portion of the groove and the exterior border of the groove are provided with second and third portions of the fixing device 50. For example, the exterior border of the groove is provided with the hooks (second portion) of a hook and loop fastener and the interior border of the groove 54 is provided with the loops (third portion) of the hook and loop fastener. The second portion and the third portion of the fixing device is then connected through an opening of the visor that forms, as described above, the first portion of the fixing device 50.

According to an embodiment, the base body 8 comprises abutments 60 for the visor 30. The abutments 60 are adapted to maintain the visor 30 in a pre-stressed bent configuration around the central axis X-X when the fixing means 31 fix the visor to the base body 8. In this bent configuration, the visor 30 is essentially in a part cylindrical shape. The abutments 60 are generally defined by the bottom of the fixing groove 54 at the lateral borders 24, 26 of the visor opening 18. In case a closing means is provided at a lateral border 24, 26, also the closing means defines an abutment 60. The two abutments 60 are spaced apart with an effective width, which is smaller than an effective width of the visor 30 when in the non-constraint configuration.

Further, the hood is provided with a spacing element 62 adapted to hold the upper border 34 of the visor 30 in a predetermined distance from the forehead 64 of the user 10 of the hood 4. The spacing element is provided as a rigid ring 62, which is fixed or integrated into the base body 8 of the hood 4. In other embodiments, the spacing element 62 may be a portion of a ring or rod shaped. The ring 62 is fixed to the base body 8 of the hood 4, such that it extends in a substantial horizontal plane P, when the operator holds his head in an upright position. For example, the substantial horizontal plane P is provided above the eye height of the operator. In other embodiments the ring 62 is provided in an inclined position, such that a front portion 65 of the ring 62 is above the eye height of the operator 10. In other words, the front portion 65 of the spacing element is a fixed relationship with the upper border 34 of the visor 30. For example, the front portion 65 of the spacing element 62 is connected to the interior of the base body 8 at the upper border 28 or adjacent to the upper border 28 of the visor opening 18.

Thus, the spacing element 62 enables to incline the visor 30 in an oblique direction with respect to a vertical direction V, when the operator holds his head upright. For example the angle a between a vertical direction V and the visor at the central axis X-X is between 25 and 60 degrees, in particular between 30 and 50 degrees.

The front portion 65 of the spacing element 62 or the upper border 34 of the visor 30, the lower border 32 of the visor 30 supported by the cheeks of the operator and a rigidity of the visor enables a substantially stationary placement of the visor with respect face of the operator, in particular when the lower border 32 of the visor 30 is pressed on the cheeks.

The spacing element 62 enables to create space between the visor 30 and the forehead 64 to wear glasses. Further, it is possible to press the visor on the cheeks at their lower border 32 to further extend downward vision by limiting the distance between the cheeks and the visor. For example the space between the forehead 64 of the operator 10 and the upper border 34 of the visor 30 is between 3 and 10 cm, in particular between 4 and 7 cm. The distance between the cheek of the operator and the lower border 32 is between 0 and 4 cm, in particular below 1.5 cm. In particular the distance between the forehead 64 of the operator and the upper border 34 of the visor 30 is greater than the distance between the cheek of the operator and the lower border 32 of the visor 30.

In another embodiment, the spacing element 62 is supported by ears of the operator 10. In other words, the spacing element 62 may be supported by the head of the operator 10 either directly, when supported by the ears, or indirectly, as shown in the figures, where the top of the head of the operator is in abutment relationship with the interior of the base body 8 to which the spacing element 62 is fixed. For example, the spacing element 62 is provided in an envelope in the hood body 8 or fixed with rings thereto.

According to an embodiment, the hood comprises on the interior side of the base body 8 at the lower border 22 of the visor opening 18 at least one first sealing device 66. It is provided to seal a possible gap between the lower border 22 of the visor opening 18 and the cheek of the operator 10. The sealing devices 66 extend, on both sides of the nose cut-out, between the nose cut-out 40, when provided into the visor opening 18, and the respective lateral borders 24, 26 of the visor opening 18. In other embodiments, the sealing devices 66 extend almost to the ears of the operator. According to some embodiments, the sealing devices extend substantially to the upper end of the nose cut-out. Thus, the hot moisturized air coming from the mouth and nose is isolated from the visor. The sealing devices extend similarly on both sides of the nose bulge in another embodiment.

In an embodiment, the first sealing devices 66 extend in a substantially horizontal direction.

According to an embodiment, at least one second sealing device 67, extends along the lateral borders 24, 26 of the visor opening, in particular on the interior side of the base body 8. For example the at least one second sealing device 67 extends in a substantially vertical direction.

In a further embodiment, which may be combined with other embodiments enclosed herewith, at least one third sealing device 68 extends along the top or in the front of the forehead 64 of the operator 10, in particular on the interior side of the base body 8. The third sealing device 68 extends substantially in a horizontal direction or plane and follows the contour of the forehead of the operator 10.

According to an embodiment, the first sealing devices 66 are arranged between 0 and 3 cm away from the lower border 22 of the visor opening, the second sealing devices are arranged between 0 and 6 cm away from the lateral borders 24, 26 of the visor opening and the third sealing device 68 is arranged between 3 cm and 10 cm away from the upper border 28 of the visor opening.

Each sealing device 66, 67, 68 has, in its width direction a first border 66a, 67a, 68a and a second border 66b, 67b, 68b, and a longitudinal direction orthogonal to the width direction. In other words, the longitudinal direction is orthogonal to the stripes shown in FIG. 4. In other words, for the first sealing device 67, the longitudinal direction is, on the cheeks, substantially horizontal and parallel to the lower border 22 of the visor opening 18, for the second sealing device 68, the longitudinal direction is substantially parallel to the vertical direction and/or to the lateral border 26 of the visor opening 18. The longitudinal direction of the third sealing device 68 is nearly parallel to the longitudinal direction of the first sealing device 67 and/or parallel to the upper border 28 of the visor opening 18.

In some embodiments, the at least one first, second and third sealing devices 66 is/are a ribbing stretched fabric, for example like at the cuffs of s sweatshirt. According to an embodiment, the sealing devices stretches in its longitudinal direction, for example the at least one first sealing device 66 stretches in horizontal direction, the at least one second sealing device 67 stretches in vertical direction, and/or the at least one third sealing device 68 stretches horizontal direction. In an embodiment, a length of the stretched first, second and/or third sealing devices is at least 2 times greater, in particular at least 1.5 greater than the length of the respective non-stretched first, second and/or third sealing devices. When not forced in a stretched state, the at least first, second and/or third sealing devices 66, 67, 68 draws automatically back into its non-stretched state. In other words, the sealing devices are elastically stretchable.

In some embodiments, the sealing devices 66, 67, 68 cannot be stretched in their width direction, wherein the width direction is orthogonal to the longitudinal direction. In particular the width of the stretched first, second and/or third sealing devices is less than 1.2 times greater, greater than the width of the respective non-stretched first, second and/or third sealing devices.

The sealing devices 66, 67, 68 have, for example, a thickness of between 5 mm and 20 mm, in particular between 7 and 10 mm. Further, they extend in the plane of the visor 30 between 10 mm and 70 mm, in particular between 20 and 50 mm. In an embodiment, the at least one first, second and/or third sealing devices 66, 67, 68 are sewed, glued or otherwise fixed to the base body 8. For example, the sealing devices 66, 67, 68 are fixed at their first border 66a, 67a, 68a to the base body 8. For example, each of the sealing devices is fixed, in particular is only fixed, the one of their borders 66a, 67a, 68a, which is more spaced away or directed away from the visor opening 18, and, in particular is not fixed at the respective other border 66b, 67b, 68b, which is directed towards the visor opening. Further, according to some embodiments, the sealing devices 66, 67, 68 are at their ends in longitudinal direction to the base body 8. The fixing enables a movement of the second border 66b, 67b, 68b from a first position, in contact with the base body 8, to a second position, where the second border 66b, 67b, 68b is in contact with the cheek or other portions of the face of the operator 10.

According to an embodiment, the first second and third sealing devices are fabricated from polyester.

The at least one first, second and/or third sealing devices 66, 67, 68 enable to better position a mask portion and the visor of the hood 4, in particular without the need for the operator to touch the hood except for the pressing devices as explained below. According to an embodiment, the first, second and/or third sealing devices increase the comfort for the operator.

Further, the hood comprises an inhalation and exhalation device 70. The inhalation and exhalation device 70 has a mask portion 72, which has, for example, from the front, a substantially diamond shaped form. The mask portion is made of fabric and may be part of the hood body 8. The mask portion 72 is for example a mouth and nose piece of the inhalation and exhalation device 70. The upper portion 74 is adapted to the nose cut-out 40 or the nose bulge of the visor 30. The mask portion 72 has an outer circumference 76, which is sewed, glued or otherwise fixed to the base body 8.

The mask 72 comprises at least one opening, namely at least one first opening 80 for intake air from the outside 16.

In some embodiments, the mask portion may have at least one second opening 82 for expulse air from the inside 12, for example during exhaling. For example, in case the mask portion 72 has no second opening 82 for expulsing air from the inside, the air will be slowly expulsed through the fabric of the gown.

The embodiment shown in FIGS. 1 and 4 shows one first opening 80 and one second opening 82. However, in other embodiments also two or more first openings 80 and two or more second openings 82 may be provided.

Each first opening 80 includes at least one intake air one-way valve. For example, each valve comprise an outer part and an inner part, each having a diameter being greater than the diameter of the respective opening 80, 82. The outer part and the inner part are than which are snapped together. For example, one of the outer and inner parts is a female part of the valve and the other part is a male part, wherein the female part is inserted into the male part, when mounting the valve into the mask portion 72. In this case the intake air one-way valve is a rigid, plastic device.

Thus, the operator may inhale air from the outside 16 without effort. In this embodiment, the intake air is not filtered. Further, dirty air from the operators mouth and nose is prevented to exit via the at least one first opening 80. Thus, a CO₂ level inside the hood 4 is lowered thanks to the intake of fresh air.

In an embodiment, which may be combined with other embodiments disclosed herein, each second opening 82 comprises also an exhaust air one-way valve. The valve may be constructed as the intake air one-way valve and functions just vice-versa.

Further, the inhalation and exhalation device 70 comprises a filtering device 84, in particular for filtering the exhaled air of the operator 10. The filtering device 84 is placed, according to an embodiment, on the back of the operator 10. In other embodiments it may be placed at another position, for example at the back of the head.

In another embodiment, the gown and/or hood, which is made of filtering cleanroom fabric, can act as a filtering for the exhalation air. In this case, the at least one second, exhalation opening 82 is optional.

The filtering device 84 filters the exhaled air or exhaust air and directs the filtered exhaust air in the backward direction B of the operator. The filtering device may be produced of the cleanroom fabric of the gown, which filters above 95% of the particles, in particular above 99% of the particles, for example about 99.8% of the particles exhaled by the operator 10. For example particles greater than 1 micron, in particular greater than 0.5 microns are filtered.

In FIG. 4, the filtering device 84 is formed as an air buffer or pocket of cleanroom fabric for a slow filtration.

The inhalation and exhalation device 70 enables to prevent the exhale the air to the front of the operator.

The filtering device 84 is connected with at least one tubing 86 to at least one second opening 82, in particular all second openings 82. The at least one tubing is for example made of a soft cleanroom fabric as the filtering device 84. In other embodiments, the at least one tubing is air tight. Thus, the exhaled air is effectively directed to the filtering device 84.

This arrangement enables to isolate the hot moisturized air from the rest of the hood 4 by channeling the exhaled air to the filtering device 84, for example the air pocket, which is made of highly filtering fabric and located at the back of the hood 4 to minimize perturbations of the working area of the worker. Additionally, a further isolation is provided between the moisturized air and the visor 30. Further, it provides better comfort to the operator by isolating hot moisturized air outside of the hood 4 and it lowers the CO2 level by isolating CO2 charged air, outside of the coverall where operator breath.

According to an embodiment, on each lateral border and/or the lower border 22 of the visor opening 18, in particular at least at one corner between the lateral border and the lower border, a pressing device 88, in particular an end of the pressing device, is provided. For example the pressing device is in form of laces. The two laces 88 are connected to each other at the back of the neck 90 or the head 14 of the operator 10. In other embodiments, the two laces are connected on the side of the neck 90 or the head 14. At that place the length of the laces 88 is adjusted. In further embodiments, only a single lace 88 is used.

The one or more pressing devices 88 are provided outside of base body 8 or the hood 4. In particular, the complete pressing devices 88 are provided outside of the base body 8 or the hood 4.

According to an embodiment, which may be combined with other embodiments disclosed herein, the at least one pressing device 88 may be connected to the backward end 89 of the at least one first sealing devices 66. In other words, the front ends of the at least one pressing device 88 are connected to the back ends of the at least one first sealing devices 66.

According to a further embodiment, on each lateral side of the mask portion 72 the pressing devices 88 are provided. For example the pressing device is in form of laces fixed to the mask portion 72.

In particular, when the operator fixes the pressing device 88 around his head, the second border 66b, 67b, 68b of the sealing devices moves from its first position, in contact with the hood body 8, to their second position, where second border 66b, 67b, 68b is in contact with the cheeks or other portions of the face of the operator 10. Thus, a good sealing and positioning of the visor is achieved.

According to an embodiment, the upper portion 74 of the mask 72 and the lower border 32 of the visor 30 are arranged adjacent to each other in the hood. In other words, they are connected via the base body 8, in particular via (reinforced) parts of the base body 8 forming the grooves 54 for the circumference 52 of the visor and the circumference 76 of the mask portion 72. In other words, the lower border 32 of the visor and the upper portion 74 of the mask portion 72 are in a fixed relationship to each other.

When the mask portion 72 is pulled in backward direction by the pressing device 88, for example by tightening the one or more laces 88, the lower border 32 of the visor 30 is pushed against the cheek of the operator 10. Thus, an enhanced sealing between the mask 72 and the cheek of the operator 10 is provided. Hence, the at least one pressing device 88 allow a better positioning of the mask or inhalation and exhalation device 70 and the visor 30. Further, the one or more pressing devices 88 enable a better sealing between hot moisturized air and the visor 30 to prevent condensation.

According to an embodiment, the inhalation and exhalation device 70 is a passive inhalation and exhalation device.

FIG. 4 shows further a pocket 92 filled with a water absorbing material, for example salt, in particular a silica gel. The pocket 92 and/or the water absorbing material is fixed to the interior of the base body 8. According to an embodiment, the water absorbing material and/or the pocket is fixed adjacent to or on the borders 22, 24, 26, 28 of the visor opening 18. In the example shown in FIG. 4, the pocket 94 is fixed adjacent to the upper border 28 of the visor opening. In other embodiments, the water absorbing material, for example in a pocket 92, may be attached to underwear, i.e. the cloths inside the gown 1, of the operator 10. The water absorbing material thus further limits condensation on the visor.

Thus, the hood 6 has an ergonomic shape and is comfortable to wear and reduces the contamination of products to be manufactures with particles of the body of an operator.

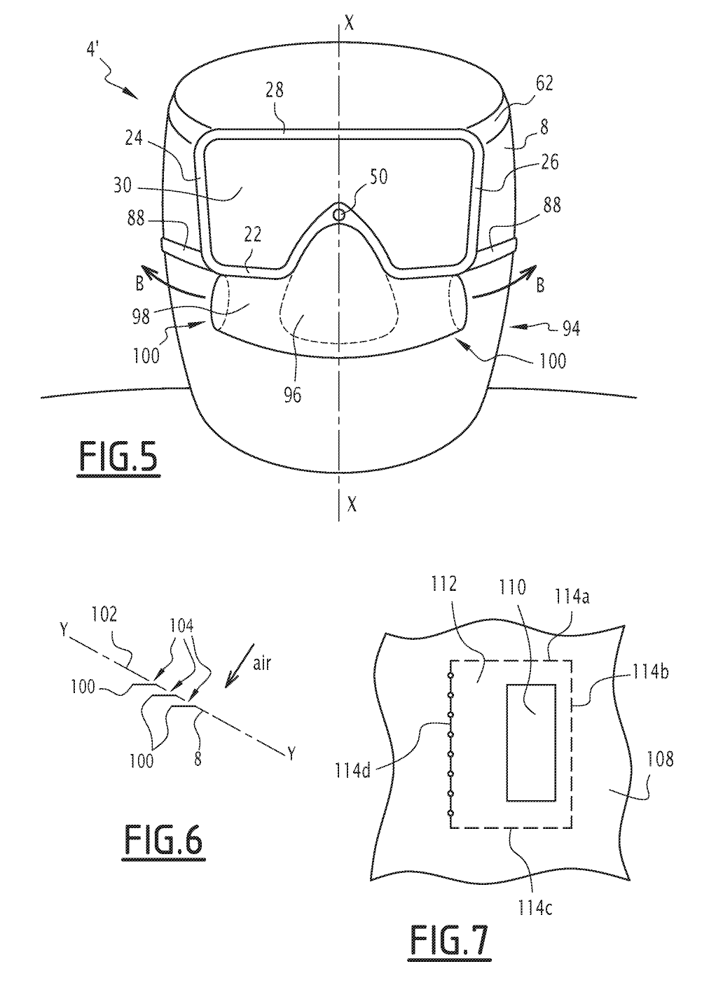

FIG. 5 shows another embodiment of the inhalation and exhalation device 94 of a hood 4′. The same features are designated with the same reference numbers as in the previous embodiments.

The hood 4′ comprises an inhalation and exhalation device 94, which is provided at the front portion of the base body 8. The inhalation and exhalation device includes a mask portion 96. For example, as shown in FIG. 5, the mask portion 96 has substantially the shape of a triangle and is placed below the nose cut-out of the visor 30. The mask portion 96 may be an opening. In other embodiments, the mask portion may be a fabric of a gas material, which leaves air though easily. The mask portion may be sewed, glued or otherwise fixed to the base body 8 of the hood 4′. The gas material provides a reduced filtering.

Further, the inhalation and exhalation device 94 comprises guiding device 98. The guiding device 98 guides the exhaled air to the backward direction B. The guiding device 98 covers completely the front of the mask portion 98 and extends on at least one side at least to the lateral borders 24, 26 of the visor opening to the backward direction. In some embodiments, the guiding device 98 extends substantially to the ears of the operator 10. For example, the guiding device 98 forms a channel, in particular between mask portion 96 and the backward end(s) 100 of the guiding device 98.

In an embodiment, the guiding device 98 is made of a soft fabric, for example cleanroom fabric provided for the gown as detailed here-above. In other words, the mask portion 96 is covered loosely by the guiding device 98.

In another embodiment, the at least one intake air one way valve, and/or the at least one exhaust air one-way valve, may be provided with fabric as shown in FIG. 6. FIG. 6 shows a section through a portion of a fabric 102. The valves are therefore gill shaped. Each valve include one or more openings 104 in form a slit, which is covered with a respective fabric portion 106 on one side of the fabric 102. Thus, a one way valve is provided. In other words, the air may pass only in the direction of the arrow through the slit openings.

FIG. 7 shows a further embodiment of a one way valve that may be used as an intake air one way valve and/or exhaust air one-way valve provided in a portion of a fabric 108. For example the fabric may be a cleanroom fabric. The fabric is provided with at least one opening 110. FIG. 7 shows a rectangular opening. However, the opening 110 may also have other forms, for example it may be circular, oval, hexagonal or the like. The at least one opening is covered with a sheet 112 of fabric having a surface which extends beyond the borders of the at least one opening 110. For example, the sheet 112 covers the at least one opening 110. For example, in case of a plurality of openings, the sheet 112 may cover all of them.

In FIG. 7 a rectangular sheet 112 is shown. However, the sheet 112 may also have other forms, for example circular, oval, hexagonal or the like. The sheet 112 is fixed to the fabric 6 in at least two, in particular three directions. In other words, the sheet 112 has four borders 114a to 114d, wherein three borders 114a to 114c are fixed to the fabric 108, for example by sewing, gluing or the like. The fourth border 114d is not fixed to the fabric 108. Thus, air may pass only in one direction through the opening 110.

In an embodiment, the sheet 112 is made of cleanroom fabric.

FIG. 8 shows a further embodiment of a hood 4″. The same features are designated with the same reference numbers as in the previous embodiments. The hood 4″ shows a variant of the embodiment of FIG. 4. Further, the hood comprises an inhalation and exhalation device 120. The inhalation and exhalation device 120 has a mask portion 122, which has, for example, from the front, a substantially triangular shaped form. The mask portion 122 has at least one first opening 124 for intake air from the outside 16.

Further, the mask portion may have at least one second opening 126 for expulse air from the inside 12, for example during exhaling. The embodiment shown in FIG. 8 shows one first opening 124 and one second opening 126. However, in other embodiments also two or more first openings 124 and two or more second openings 126 may be provided.

Each first opening 124 includes at least one intake air one-way valve, for example the intake air one-way valves as described above with respect to FIG. 4, 6 or 7.

In an embodiment, which may be combined with other embodiments disclosed herein, each second opening 126 comprises also an exhaust air one-way valve. The valve may be constructed as the intake air one-way valve.

Further, the inhalation and exhalation device 120 includes a guiding device 128 for guiding exhaled air from the at least one second opening 126 to the backward direction B. The guiding device 128 covers partly the front of the mask portion 122 at the at least one second opening 126 and extends on at least one side at least to the lateral borders 24, 26 of the visor opening to the backward direction. In some embodiments, the guiding device 128 extends substantially to the ears of the operator 10. For example, the guiding device 128 forms a channel, in particular between the at least one second opening 126 and the backward end(s) 130 of the guiding device 128.

In an embodiment, the guiding device 128 is made of a soft fabric, for example cleanroom fabric provided for the gown as detailed here-above.

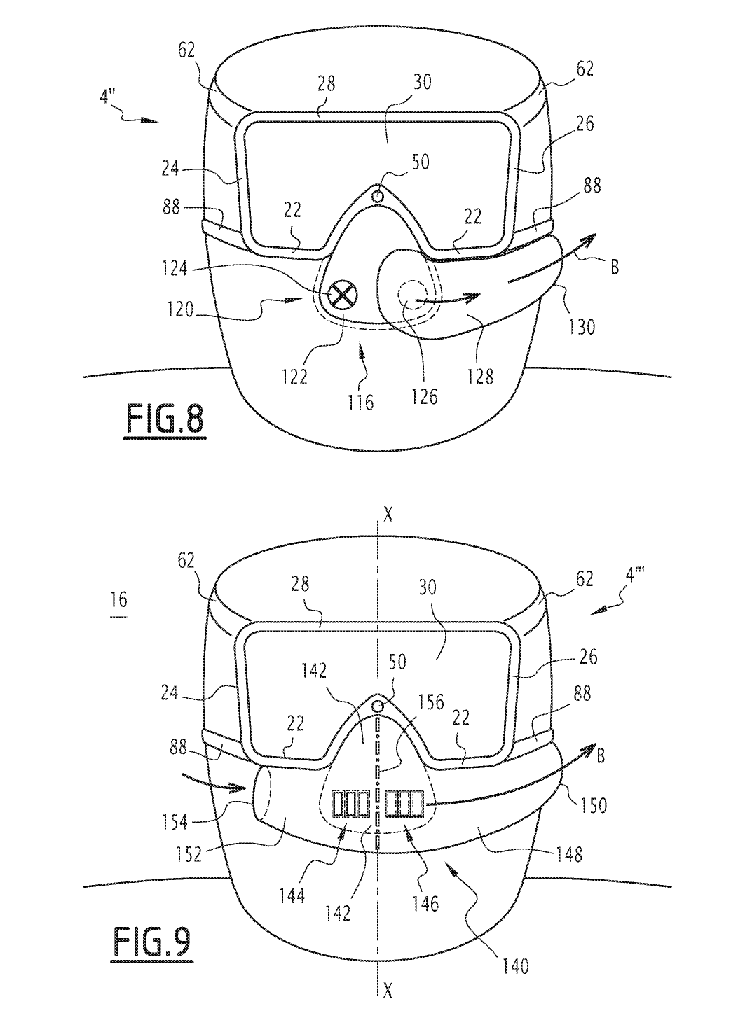

FIG. 9 shows a further embodiment of a hood 4′″. The same features are designated with the same reference numbers as in the previous embodiments. The hood 4″′ comprises an inhalation and exhalation device 140. The inhalation and exhalation device 140 has a mask portion 142, which has, for example, from the front, a substantially triangular shaped form. For example, the mask portion 142 may be nose shaped.

The mask portion 142 has at least one first opening 144 for intake air from the outside 16. Here, three openings are shown. However, also more or less first openings 144 may be provided.

Further, the mask portion may have at least one second opening 146 for expulse air from the inside 12, for example during exhaling. Here, three openings are shown. However, also more or less first openings 146 may be provided.

Each first opening 144 includes at least one intake air one-way valve, for example the intake air one-way valves as described above with respect to FIG. 6 or 7. In other words, the intake air one-way valves are similar to gills.

In an embodiment, which may be combined with other embodiments disclosed herein, each second opening 146 comprises also an exhaust air one-way valve. The valve may be constructed as the intake air one-way valve. In other words, the exhaust air one-way valve may be as described above with respect to FIG. 6 or 7. In other words, the exhaust air one-way valves are similar to gills.

In an embodiment, the inhalation and exhalation device 140 includes a first guiding device 148 for guiding exhaled air from the at least one second opening 146 to the backward direction B. The guiding device 148 covers partly the front of the mask portion 142 at the at least one second opening 146 and extends on at least one side at least to the lateral borders 24, 26 of the visor opening to the backward direction. In some embodiments, the guiding device 148 extends substantially to the ears of the operator 10. For example, the guiding device 148 forms a channel, in particular between the at least one second opening 146 and the backward end(s) 150 of the guiding device 148.

According to an embodiment, the inhalation and exhalation device 140 includes a second guiding device 152 for guiding intake air from outside 16 to the at least one first opening 144. The guiding device 152 covers partly the front of the mask portion 142 at the at least one first opening 146 and extends on at least one side at least to the lateral borders 24, 26 of the visor opening to the backward direction.

In some embodiments, the guiding device 152 extends substantially to the ears of the operator 10. For example, the guiding device 142 forms a channel, in particular between the at least one first opening 144 and the backward end(s) 154 of the guiding device 152.

According to an embodiment the first guiding device 148 is arranged on a first side of the hood 4″′ and the second guiding device 152 is arranged on the opposite side of the hood with respect to the first guiding device 148.

In an embodiment, the first and second guiding device 148, 152 is made of a soft fabric, for example cleanroom fabric provided for the gown as detailed here-above.

According to an embodiment, the first and second guiding devices 148, 152 are separated from each other, to avoid mixing intake air and exhaled air.

For example, the first and the second guiding device 148, 152 may be made of a single fabric, whereas it is fixed, in particular sewed or glued along the central axis X-X to the mask portion 142. FIG. 9 shows a seam 156 along the central axis X-X. Of course, the fabric may be also fixed at other portions to the mask portion 142.

According to an embodiment, the inhalation and exhalation device is a passive inhalation and exhalation device.

According to embodiments disclosed herein, the inhaled air and the exhaled air is completely separated, in particular due to the guiding devices. For example, the guiding devices guide the exhaled air to the backward direction B. The inhalation and exhalation device retrieves intake air for inhalation from a first direction, in particular in a front or first side direction, and to exhaust exhaled air in a second direction (B) being different of the front direction or first side direction, wherein the second direction may be a backward direction.

In some embodiments disclosed herein, the guiding devices are provided at the hood, in particular at the head or neck portion of the hood.

The cleanroom fabric is made by cleanroom polyester filament fabric or any other material suitable for cleanroom use. The cleanroom polyester filament fabric can be with or without carbon.

In the following the usage of the hood 4, 4′ is explained.

In case, the visor has to be inserted via an insertion opening by sliding into the visor opening, the visor 30 is fixed to the base body 8 by means of the following steps. In an initial configuration, the visor 30 is in its flat non constraint configuration and completely outside the fixing groove 54. The visor 30 is inserted either into the fixing groves 54, in particular by sliding the visor 30 through the insertion opening until the visor 30 abuts against the abutment 60 opposite the insertion opening. The visor 30 is bent around the axis X-X until the effective width of the visor 30 is smaller than the effective with of the abutments 60. In this configuration of the visor 30, the closing means, if used, are closed or fastened.

Then the visor 30 stays in the pre-stressed bent configuration against the abutments 60.

The sliding direction of the visor 30 during insertion depends on the arrangement of the insertion opening, i.e. whether the insertion opening is on the left border 24, the right border 26 or on the top border 28 of the visor opening 18. The visor 30 is economic in manufacture and can be readily replaced if damaged.

In other embodiments, it is not necessary to provide an insertion opening for inserting the visor.

Then the one or more pressing devices 88 are fixed and tightened, such that the lower border 32 of the visor and thus the lower border 22 of the visor opening 18 and the sealing devices 66 are pressed against the cheeks of the operator 10 to isolate the visor 30 from the breathing air.

Thus, the spacing element 62, the sealing devices 66, 67, 68 and/or the pressing device 88 enable to incline the visor 30 in an oblique direction with respect to a vertical direction V, when the operator holds his head upright, so that he has a comfortable view in the downward direction. At the same time, these features reduce the risk of fog of the visor 30. It should be noted that these features may be used in all embodiments of the present even if it is not shown in FIGS. 5, 8 and 9.

Thus, the products manipulated by the operator are better protected against particles emitted from the operator.

1. A hood for a cleanroom gown, the hood comprising a base body defining an outside and an inside adapted to receive a head of an operator, the base body having a visor opening having a lower border and an upper border, wherein the hood includes a visor fixed in the visor opening, wherein the visor comprises a visor circumference with an upper border and a lower border, the lower border of the visor comprising a nose cut-out or a nose bulge provided for a nose of the operator, characterized in that the hood further comprises at least one fixing device arranged at an upper end of the nose cut-out or at the front end of the nose bulge for releasably fixing the lower border of the visor opening to the visor.

2. The hood for a cleanroom gown according to claim 1, wherein the hood defining a central axis, the nose cut-out or the nose bulge of the visor being symmetrically to the central axis, wherein at least one of the fixing devices is arranged on the central axis.

3. The hood for a cleanroom gown according to claim 1, wherein the fixing device includes a first portion arranged on the visor and a second and/or third portion arranged at the lower border of the visor opening.

4. The hood for a cleanroom gown according to claim 1, wherein the fixing device is a pressure button, a press snap button and/or a hook and loop fastener.

5. The hood for a cleanroom gown according to claim 1, wherein the visor is releasably fixed to the base body by a fixing groove extending around the visor opening and adapted to receive the visor circumference.

6. The hood for a cleanroom gown according to claim 1, wherein the nose cut-out has a length between the upper end and a lower end between 3 and 6 cm, in particular between 4 and 5 cm.

7. The hood for a cleanroom gown according to claim 1, further comprising at least one spacing element adapted to hold the upper border of the visor in a predetermined distance from the forehead of the operator, wherein, in particular the predetermined distance is between 3 and 10 cm.

8. The hood according to claim 7, wherein the at least one spacing element is adapted to be supported by at least one portion of the head of the operator and/or is rigid, in particular is a rigid ring, fixed to the base body.

9. The hood for a cleanroom gown according to claim 1, further comprising at least one sealing device arranged at the lower border of the visor opening adapted to seal a space between the lower border of the visor opening and a portion of the face, in particular the cheeks, of the operator, wherein the, in particular the each sealing device, extends between the nose cut-out of the visor and one of the lateral borders (24, 26) of the visor opening.

10. The hood for a cleanroom gown according to claim 9, wherein the sealing device has a thickness of between 5 mm and 2 cm, in particular between 7 mm and 10 mm.

11. The hood for a cleanroom gown according to claim 1, further comprising an inhalation and exhalation device adapted to retrieve intake air for inhalation from a first direction, in particular in a front direction, and to exhaust exhaled air in a second direction being different of the front direction, wherein, in particular, the inhalation and exhalation device is a passive device.

12. The hood for a cleanroom gown according to claim 11, wherein the inhalation and exhalation device includes a mask portion comprising at least one one-way valve, in particular one intake air one-way valve and/or one exhaust air one-way valve.

13. The hood for a cleanroom gown according to claim 11, wherein the inhalation and exhalation device includes a filtering device for filtering the exhaled air, wherein, in particular, the filtering device is connected to the mask portion with a tubing and/or includes a filtering fabric for filtering particles.

14. The hood for a cleanroom gown according to claim 1, further comprising a releasable pressing device for pressing the mask portion onto the face of the operator and/or for pressing the lower border of the visor against the cheek of the operator, wherein, in particular, the pressing device is provided on the outside of the hood.

15. A cleanroom gown comprising a body portion, arms, legs and the hood according to claim 1.
